(19) United States
(12) Patent Application Publication
(10) Pub. No.: US 2002/0082915 A1
(43) Pub. Date: Jun. 27, 2002

(54) Observational skill testing product

(76) Inventors: Leonard Reiffel, Chicago, IL (US); Evan C. Reiffel, Chicago, IL (US)

Correspondence Address: DONALD F MOYER, 431 S DEARBORN 705, CHICAGO, IL, 60605

(21) Appl. No.: 09/951,667

(22) Filed: Sep. 11, 2001

Related U.S. Application Data
(63) Continuation-in-part of application No. 09/280,603, filed on Mar. 29, 1999, now abandoned.

(51) Int. Cl. G06F 17/60; G09B 3/00

(52) U.S. Cl. 705/14; 434/332

(57) ABSTRACT

The product—which is adapted for use with an information transmission system—presents an original image; uses criteria to present a test image, where the test image has a non-alphanumeric element perceptively distinguishable from a corresponding element of the original image and to invite responses which locate the distinguishable element of the test image; and generates data relating the responses to the criteria.

This is a continuation-in-part of application 09/280,603 filed Mar. 29, 1999.

The product—which is adapted for use with an information transmission system—presents an original image; uses criteria to present a test image, where the test image has a non-alphanumeric element perceptively distinguishable from a corresponding element of the original image, and to invite responses which locate the distinguishable element of the test image; and generates data relating the responses to the criteria.

The product provides progress over prior art such as that shown in U.S. Pat. Nos. 3,671,668 by Reiffel Jun. 20, 1972, 3,718,759 by Reiffel Feb. 27, 1973, 4,926,255 by Van Kohorn May 15, 1990, 5,035,625 by Munson Jul. 30, 1991, 5,494,444 by Thayer Feb. 27, 1996, 5,855,008 by Goldhaber Dec. 29, 1998, and 6,055,573 by Gardenswartz Apr. 25, 2000, 6,120,300 by Ho Sep. 19, 2000 and in Brewer, James David, THE UNDERMINING AND ENHANCING EFFECTS OF EXTRINSIC REWARDS AND EFFECTANCE FEEDBACK ON INTRINSIC MOTIVATION: A DEVELOPMENTAL STUDY, 1980, The Ohio State University, page 1480 and Kamal, Ahmed Fouad, SOCIAL ENVIRONMENT AND INCENTIVES AS MOTIVATORS IN SWIMMING, 1980, Indiana University, page 2498

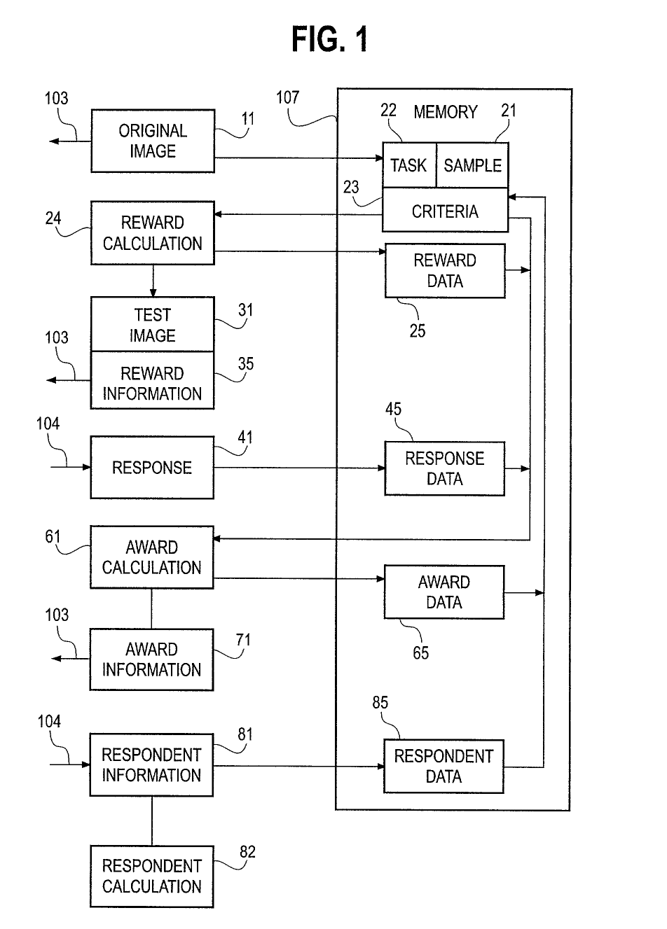

FIG. 1 schematically depicts the product.

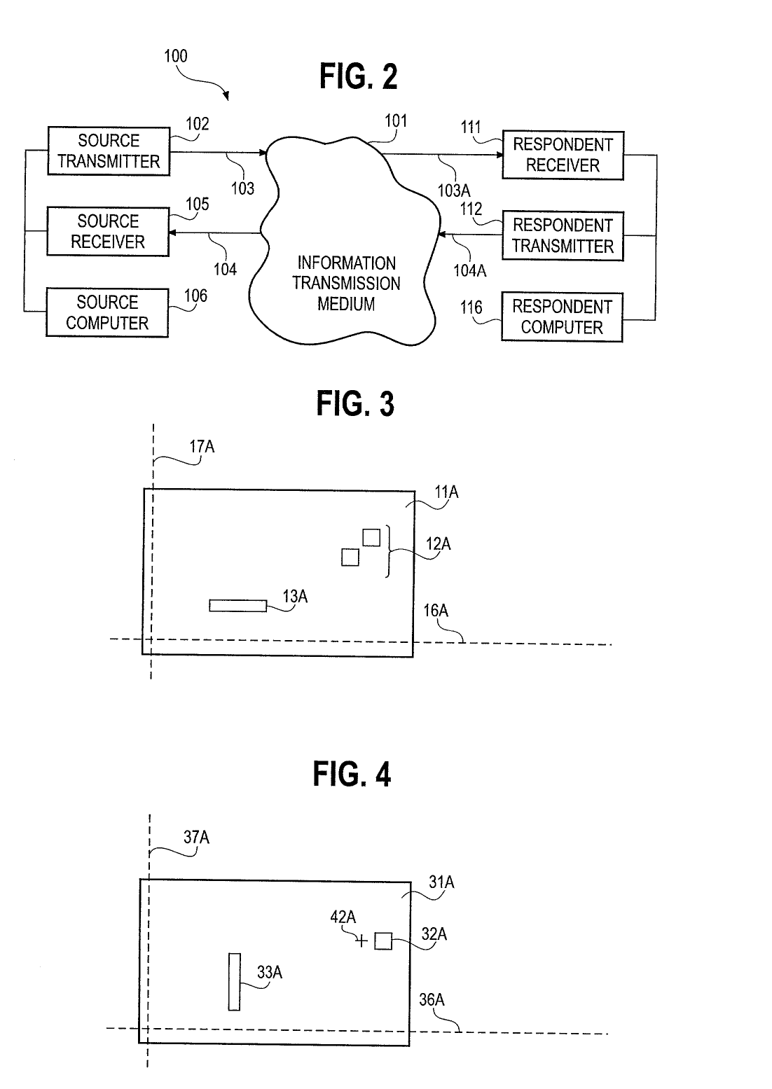

FIG. 2 schematically depicts an information transmission system.

FIG. 3 depicts original elements in an original image.

FIG. 4 depicts test elements in a test image.

The product can be implemented many ways and is especially well adapted for use via a network such as the internet. A person can be viewing an internet site page with a link which informs the person that an observational skill test and a reward might be available if the person activates the link.

When the link is activated a calculation is made. Information can then be sent by a source to be received by the person at a first time.

The information provides a test image and invites the person to locate an element in the test image which is perceptively distinguishable from a corresponding element in an original image. The original image can be an image on the internet site page and can be available by various other means.

The person can locate the distinguishable element by a second time by various data entry means. A response can be caused by the person.

After the response is received a calculation is made. If the response satisfies criteria, then award information can be sent to the respondent. The award information can request that the respondent provide respondent information so that the award can be provided to the respondent.

The product is especially distinguished by the test of locating non-alphanumeric changes between images and by the use of criteria to set the test and measure the test.

While the internet is well adapted for the product, the product can be used with any adapted information transmission system having elements such as those depicted in FIG. 2. An adapted system comprises an information transmission medium 101; a source transmitter 102 which can send source information 103 via the information transmission medium; and a source receiver 105 which can receive replies 104 via the information transmission medium.

An adapted system also comprises a source computer 106 signal connected to the source transmitter, to the source receiver, and to a memory 107.

An adapted system also comprises a respondent receiver 111 which can receive receptions 103A via the information transmission medium where the receptions are caused at least in part by the source information; a respondent transmitter 112 which can send transmissions 104A via the information transmission medium, with the transmissions causing at least part of the replies.

An adapted system can also comprise a respondent computer 116 which can be signal connected to the respondent receiver, to the respondent transmitter, and to both.

In an internet form of the product, the internet is the information transmission medium, the source transmitter is a transmission component of, and the source receiver is a reception component of, a connection to the internet of the source computer. Similarly, the respondent receiver is a transmission component of, and the respondent transmitter is a transmission component of, a connection to the internet of a respondent device.

The original image 11, 11A has original coordinates 16A, 17A. The original image has original elements—for example 12A, 13A—which are located relative to the original coordinates. There can be many original elements.

A first element—for example 12A—from the original elements has a first location relative to the original coordinates. An original image signal representing the original image is adjoined to the source information 103.

Criteria 23—which can comprise sample criteria 21 and task criteria 22—are stored in the memory. A reward calculation 24 using the criteria is made. Preferably the reward calculation is made by the source computer, but can be done by other means.

The reward calculation causes the source transmitter to send reward information 35 adjoined to the source information. The reward information is received by the respondent receiver adjoined to the receptions at a first time. The reward calculation can cause the reward information to be sent to a respondent receiver only if requested via the transmissions and can be sent even if not requested.

A test image 31, 31A is adjoined to the reward information. The test image has test coordinates 36A, 37A which member-by-member correspond to the original coordinates of the original image. The test image has test elements—for example 32A, 33A which are located relative to the test coordinates.

The test element locations member-by-member correspond to the original element locations. Original elements at original locations member-by-member correspond to test elements at corresponding test elements. Each test element is perceivably distinguishable from each corresponding original element.

A reward element—for example 32A—from the test elements is perceivably distinguishable from the corresponding first element 12A. There can be many reward elements.

The reward element has a reward location relative to the test coordinates. The reward location corresponds to the first element location relative to the original coordinates.

The reward calculation selects the reward element and any other reward elements from the test elements. Reward data 25 representing the reward information are stored in the memory. Preferably the reward data are stored in the memory by the reward calculation, but the reward data can be stored in the memory by other means.

The reward information invites a response to locate the reward element A response 41 is sent at a second time adjoined to the transmissions. The response is received by the source receiver adjoined to the replies. The response represents at least a first response location 42A relative to the test coordinates.

Response data 45 are stored in the memory. Preferably the response data are stored in the memory by the source computer, but the response data can be stored in the memory by other means. The response data represent at least the first response location. The response data can also represent the time interval between the first time and the second time.

An award calculation 61 can use the criteria, the reward data, and the response data. The award calculation can relate the response data to the reward location and to the criteria. Thus, the award calculation can relate the response location to the reward location and to the criteria and can relate the time interval to the criteria. Preferably the award calculation is made by the source computer, but can be done by other means.

Award data 65 representing results of the award calculation are stored in the memory. Preferably the award data are stored in the memory by the source computer, but can be done by other means.

Award information 71 representing at least part of the award data can be sent adjoined to the source information and received adjoined to the receptions. Award information can solicit respondent information.

Respondent information 81 can be sent adjoined to the transmissions and received adjoined to the replies. An respondent calculation 82 can be made using criteria and the respondent information. The respondent calculation causes respondent data 85 representing the respondent information to be stored in the memory. Preferably the respondent calculation is made by the source computer, but can be done by other means.

The respondent calculation can cause the respondent data to be used to revise the criteria. The respondent calculation can cause the respondent data to be used to revise the criteria only if sample criteria are met prior to the revision. The respondent calculation can use award data along with respondent data to revise the criteria.

Respondent information can be solicited by the reward information. The respondent calculation can be a component of the award calculation.

Respondent information can be solicited along with the original information. The respondent calculation can be a component of the reward calculation and can cause reward information to be sent only if criteria are met.

The product can use sample criteria which are not known by a respondent, thus minimizing sample bias. Sample bias is further minimized here because the data can be added to the sample only if sample criteria are met.

Various sample criteria can be used. In one example, sample criteria can comprise a routine by which reward information is sent only if a randomly occurring condition is met. In another example, sample criteria can include routines by which data are added to the sample only if the respondent will improve the sample by making the sample more closely represent a target population. Information, such as the respondent's zip code, can be used along with the sample criteria to decide if the respondent would make an accumulating sample more representative of a target population.

Also, the reward calculation can use task criteria to choose the reward elements from the test elements in order to minimize reward earning responses based on means other than understanding the original image. Choice of test elements can be made according to results from studies of how people understand information, studies which can be enhanced by the testing product here.

Because the reward calculation can select the reward information and the reward elements by means of task criteria not known by a respondent, the respondent then can not have prior knowledge of the reward elements nor the reward information and thus can only learn about the reward elements and the reward information from the reward information. Task criteria can be devised using results learned from studies of how people understand information, which can minimize using data from responses not made by a person.

The source computer makes an award calculation to determine if a response has earned an award. Award data and respondent data can be used to study ways respondents go about understanding information and can be also used to revise sample criteria and task criteria in order to progressively improve the testing product.

Task criteria can also specify how a response can earn an award. A response which identified some moderate percentage, such as fifty percent, of the reward elements in a moderate time interval, such as twenty seconds, can earn a small award. Multiple respondents can be responding and the response which identified the greatest number of the reward elements in a set time interval can earn a very large award. Many variations around these examples can be used.

Task criteria can set shorter time intervals to earn an enhanced award. Task criteria can set a higher level of locating precision to earn an enhanced award.

Various combinations of time interval and precision can be used.

The sample criteria and the task criteria can specify several levels of reward information. The award earned at one level of reward information can be the right to receive the next highest level of reward information. Award data generated by a response at one level can used along with the sample criteria and the task criteria in the reward calculation for a subsequent level.

Reward information can be sent to a selected respondent at an announced time. A plurality of selected respondents can be chosen to compete against each other in locations which would draw great attention. Groups of selected respondents can compete at a plurality of such locations. The locations can be locations associated with the image. Respondents can be selected by their achievements making responses to the reward information at a prior time.

When the reward calculation compares times, then times can be synchronized with time standards, such as those of the U. S. National Institute of Standards and Technology, to an acceptable accuracy. Data encryption techniques can be used to foil alterations of the data after the second time.

The invention can be used with various information transmission media ranging from a person making a speech on a street comer to various combinations of information transmission systems. The original image can be transmitted by one means, the reward information by a second means, and the response transmitted by a third means.

The original image and can be transmitted via a television broadcast, the reward information transmitted via the internet, and the response transmitted via a phone. The product can use radio, pagers, other communication devices, printed publications and combinations of these. Portions of the reward information can be transmitted separately via several transmission media.

The original image can be made available well before the first time, giving an incentive for people to understand the original image in anticipation of an opportunity to earn an award by locating reward elements in a test image at a later time.

The original image and the test image can have various forms which can be perceived by persons via various sensory pathways such as visual, audible, tactile, and combinations of these and other sensory pathways. Since the product tests observational skill, test elements in visual images are portions of the images which are not alphanumeric. (By definition here “alphanumeric” is limited to visual forms, thus no portions of audible, tactile and other non-visual forms can be alphanumeric.)

Images can be in formats where the image unfolds through time, such as cinematic formats, can be in formats where all of the image does not unfold through time, such as page-by-page formats, and by various combinations of these and other formats.

Test elements can be perceivably distinguishable from original elements in various ways such as by changes in physical properties such as intensity, frequency, shape, number, orientation, relative locations of several elements, motions, and combinations of these and other physical properties.

The several calculations and causes here can act via any of various processing modes. The processing can utilize configured processing elements such as fixed circuits, can utilize configurable processing elements such as field programmable gate arrays and neural networks, can utilize instructions in a data-bearing medium, and can utilize combinations of these and other forms. The processing can be stand alone, can act via a local information system, can act via a networked information system, and can act via combinations of these and other forms.

A “signal” from a first product part to a second product part and a first product part being “signal connected” with a second product part here, and throughout, mean that a first physical state of the first product part causes a second physical state of the second product part. This can occur by various direct causal means and can occur by any of various transmission means.

Transmitted signals can be any of various point-to-point and broadcast forms of energy transmission such as wireless and via wires, cables, and fibers. Parts of transmitted signals can reside with one form of the transmitted signal, parts can reside with a second form of transmitted signal, and parts can reside with various combinations of transmitted signals.

Claimed is:

1. An observational skill testing product adapted for use with an information transmission system, the information transmission system comprising:
an information transmission medium;
a source transmitter;
source information sent by the source transmitter via the information transmission medium;
a source receiver;
replies received by the source receiver via the information transmission medium;
a source computer being signal connected to the source transmitter and to the source receiver;
a memory being signal connected to the source computer;
a respondent receiver;
receptions received by the respondent receiver via the information transmission medium,
the receptions in part at least being caused by the source information;
a respondent transmitter; and
transmissions sent by the respondent transmitter via the information transmission medium,
the transmissions causing at least a part of the replies;
the observational skill testing product comprising:
an original image,
the original image having original coordinates,
the original image having original elements;
a first element from the original elements,
the first element having a first location relative to the original coordinates,
the first element not being alphanumeric;
criteria stored in the memory;
a reward calculation,
the reward calculation using the criteria;
reward information,
the reward calculation causing the source transmitter to send the reward information adjoined to the source information,
the reward information being received at the respondent receiver adjoined to the receptions at a first time;
a test image,
the test image being adjoined to the reward information,
the test image having test coordinates,
the test coordinates member-by-member corresponding to the original coordinates,
the test image having test elements;
a reward element from the test elements,
the reward element having a reward location relative to the test coordinates,
the reward location corresponding to the first location relative to the original coordinates of the first element from the original elements,
the reward element being perceivably distinguishable from the first element,
the reward element not being alphanumeric,
the reward element being selected from the test elements by the reward calculation;
reward data,
the reward data being stored in the memory,
the reward data representing the reward information;
a response,
the response being invited by the reward information,
the response representing a response location relative to the test coordinates,
the response being sent by the respondent transmitter adjoined to the transmissions at a second time,
the response being received by the source receiver adjoined to the replies;
response data,
the response data representing the response location,
the response data being stored in the memory;
an award calculation using the criteria, the reward data, and the response data,
the award calculation relating the response to the reward location and to the criteria; and
award data stored in the memory,
the award data representing results of the award calculation.

2. The product of claim 1 further comprising:
respondent information,
the respondent information being sent by the respondent transmitter adjoined to the transmissions.
the respondent information being received by the source receiver adjoined to the replies; and
a respondent calculation,
the respondent calculation using the criteria and the respondent information,
the respondent calculation causing respondent data representing the respondent information to be stored in the memory.

3. The product of claim 2 wherein the respondent information is elicited along with the original image.

4. The product of claim 3 wherein the reward calculation sends reward information only if the respondent calculation has determined that the respondent data meet the criteria.

5. The product of claim 2 wherein the respondent information is elicited by the reward information.

6. The product of claim 5 wherein the respondent calculation causes the respondent data to be used to revise the criteria only if the respondent data meet the criteria before revision.

7. The product of claim 2 further comprising:
award information,
the award calculation causing the award information to be sent by the source transmitter adjoined to the source information,
the award information being received by the respondent receiver adjoined to the receptions.

8. The product of claim 7 wherein the respondent information is elicited by the award information.

9. The product of claim 8 wherein the respondent calculation causes the respondent data to be used to revise the criteria only if the respondent data meet the criteria before revision.

10. The reward system of claim 1 wherein a selected respondent receives reward information at an announced time.

11. An observational skill testing product adapted for use with an information transmission system, the information transmission system comprising:
an information transmission medium;
a source transmitter;
source information sent by the source transmitter via the information transmission medium;
a source receiver;
replies received by the source receiver via the information transmission medium;
a source computer being signal connected to the source transmitter and to the source receiver;
a memory being signal connected to the source computer;
a respondent receiver;
receptions received by the respondent receiver via the information transmission medium,
the receptions in part at least being caused by the source information;
a respondent transmitter and;
transmissions sent by the respondent transmitter via the information transmission medium,
the transmissions causing at least a part of the replies.
the observational skill testing product comprising:
an original image,
the original image having original coordinates,
the original image having original elements;
a first element from the original elements,
the first element having a first location relative to the original coordinates,
the first element not being alphanumeric;
criteria stored in the memory;
respondent information,
the respondent information being sent by the respondent transmitter adjoined to the transmissions,
the respondent information being received by the source receiver adjoined to the replies;
a respondent calculation,
the respondent calculation using the criteria and the respondent information,
the respondent calculation causing respondent data representing the respondent information to be stored in the memory;
a reward calculation,
the reward calculation using the criteria;
reward information,
the reward calculation causing the source transmitter to send the reward information adjoined to the source information,
the reward information being received by the respondent receiver adjoined to the receptions at a first time,
the reward information being sent only if the respondent calculation has determined that the respondent data meet the criteria;
a test image,
the test image being adjoined to the reward information,
the test image having test coordinates,
the test coordinates member-by-member corresponding to the original coordinates,
the test image having test elements;
a reward element from the test elements,
the reward element having a reward location relative to the test coordinates,
the reward location corresponding to the first location relative to the original coordinates of the first element from the original elements,
the reward element not being alphanumeric,
the reward element being perceivably distinguishable from the first element,
the reward element being selected from the test elements by the reward calculation;
reward data,
the reward data being stored in the memory,
the reward data representing the reward information;
a response,
the response being invited by the reward information,
the response representing a response location relative to the test coordinates,
the response being sent by the respondent transmitter adjoined to the transmissions at a second time, and being received by the source receiver adjoined to the replies;
response data,
the response data representing the response location,
the response data being stored in the memory;
an award calculation,
the award calculation using the criteria, the reward data, and the response data,
the award calculation relating the response to the reward location and to the task criteria; and
award data, the award data representing results of the award calculation,
the award data being stored in the memory.

12. The product of claim 11 wherein the respondent information is elicited along with the original image.

13. An observational skill testing product adapted for use with an information transmission system, the information transmission system comprising:
an information transmission medium;
a source transmitter;
source information sent by the source transmitter via the information transmission medium;
a source receiver;
replies received by the source receiver via the information transmission medium;
a source computer being signal connected to the source transmitter and to the source receiver;
a memory being signal connected to the source computer;
a respondent receiver;
receptions received by the respondent receiver via the information transmission medium,
the receptions in part at least being caused by the source information;
a respondent transmitter and;
transmissions sent by the respondent transmitter via the information transmission medium,
the transmissions causing at least a part of the replies;
the observational skill testing product comprising:
an original image,
the original image having original coordinates,
the original image having original elements;
a first element from the original elements,
the first element having a first location relative to the original coordinates,
the first element not being alphanumeric;
criteria stored in the memory;
a reward calculation,
the reward calculation using the criteria;
reward information,
the reward calculation causing the source transmitter to send the reward information adjoined to the source information,
the reward information being received by the respondent receiver adjoined to the receptions at a first time;
a test image,
the test image being adjoined to the reward information,
the test image having test coordinates,
the test coordinates member-by-member corresponding to the original coordinates,
the test image having test elements;
a reward element from the test elements,
the reward element having a reward location relative to the test coordinates,
the reward location corresponding to the first location relative to the original coordinates of the first element from the original elements,
the reward element being perceivably distinguishable from the first element,
the reward element not being alphanumeric,
the reward element being selected from the test elements by the reward calculation;
reward data,
the reward data being stored in the memory,
the reward data representing the reward information;
a response,
the response being invited by the reward information,
the response representing a response location relative to the test coordinates,
the response being sent by the respondent transmitter adjoined to the transmissions at a second time,
the response being received by the source receiver adjoined to the replies;
response data,
the response data representing the response,
the response data being stored in the memory;
an award calculation made by the source computer using the criteria, the reward data, and the response data,
the award calculation relating the response to the reward data and to the criteria,
award data,
the award data being stored in the memory,
the award data representing results of the award calculation;
award information,
the award calculation causing the award information to be sent by the source transmitter adjoined to the source information,
the award information being received by the respondent receiver adjoined to the receptions;
respondent information,
the respondent information being sent by the respondent transmitter adjoined to the transmissions,
the respondent information being received by the source receiver adjoined to the replies; and
a respondent calculation,
the respondent calculation causing respondent data representing the respondent information to be stored in the memory,
the respondent calculation causing the respondent data to be used to revise the criteria only if the respondent data meet the criteria before revision.

14. The product of claim 13 wherein the respondent information is elicited by the reward information.

15. The product of claim 13 wherein the respondent information is elicited by the award information.
